(19) United States
(12) Patent Application Publication
(10) Pub. No.: US 2022/0260267 A1
(43) Pub. Date: Aug. 18, 2022

(54) DEVICE FOR TREATING, IN PARTICULAR DISINFECTING, AIR, IN PARTICULAR ROOM AIR, OR SURFACES

(71) Applicant: DEBETEK GmbH, Maroldsweisach (DE)

(72) Inventor: Richard HIPP, Maroldsweisach (DE)

(21) Appl. No.: 17/193,664

(22) Filed: Mar. 5, 2021

(30) Foreign Application Priority Data
Feb. 17, 2021 (DE) 20 2021 100 771.0

(51) Int. Cl. F24F 8/133; F24F 8/108; F24F 8/80; F24F 11/52; F24F 11/77; B60H 3/00; B60H 1/00

(52) U.S. Cl. CPC F24F 8/133; F24F 8/108; F24F 8/80; F24F 11/52; F24F 2110/66; B60H 3/0007; B60H 1/008; B60H 1/00828; B60H 1/00985; F24F 11/77

(57) ABSTRACT

Device for treating air and/or surfaces with treatment substance for disinfecting, can include a blower for sucking and blowing air, at least one conveying device for conveying the treatment substance, and at least one feed nozzle for feeding the treatment substance, wherein the feed nozzle is connectable to the conveying device via a connection line. The at least one feed nozzle can be arranged in the air flow of the blower, wherein the at least an end of a feed nozzle is removable and can also be arranged at a distance from the device, and can be connected to a ventilation duct of a ventilation and/or air-conditioning system of an environment. Additionally or alternatively, at least one further feed nozzle, which is connected or connectable to the conveying device via a connecting line, can be connected to a ventilation duct of a ventilation and/or air-conditioning system of the environment.

### CROSS-REFERENCE TO RELATED APPLICATIONS

The present invention claims the benefit of priority to German Utility Model Patent Application No. 20 2021 100 771.0, filed on Feb. 17, 2021, entitled “Vorrichtung zum Behandeln, insbesondere Entkeimen oder Desinfizieren von Luft, insbesondere Raumluft, oder Oberflächen,” the entire content which is incorporated herein by reference.

### BACKGROUND OF THE INVENTION

### 1. Field of the Invention

The invention relates to a device for treating, in particular disinfecting or sterilising, air, in particular room air, or surfaces. Furthermore, the invention relates to a ventilation and/or air-conditioning system.

### 2. The Relevant Technology

The room air in buildings, vehicles, ships and aircraft, is often treated to eliminate or at least inactivate pollutants, pathogens (germs) and contaminants in the room air. In this way, the room air and surfaces and ventilation systems can be sterilised and disinfected, but also cleaned, humidified, enriched, refreshed and/or scented. For example, by adding diluted aqueous hydrogen peroxide, germs, viruses, bacteria, mould, biological contaminants, pathogenic germs and airborne pollutants in the air and on surfaces are inactivated. Hydrogen peroxide decomposes into water and oxygen, so that the room air is enriched with oxygen and also humidified.

Rooms in buildings are ventilated in different ways, for example by opening and closing the windows, by a ventilation system or by an air-conditioning system. Different rooms in a building can also be ventilated in different ways. For different types of ventilation, different devices for treating the air in the room are also necessary or appropriate.

### BRIEF SUMMARY OF THE INVENTION

The invention is based on the task of providing a compact device for treating, in particular disinfecting or sterilising, air, in particular room air, or surfaces, which can be flexibly adapted to the spatial and technical conditions on site.

This task is solved in particular by the device according to claim 1.

The device is provided for treating, in particular disinfecting (or: sterilising), air, in particular room air, or surfaces with treatment substance (or: treatment agent), in particular a disinfectant (or: sterilising agent, biocide).

The device comprises at least one blower (or: fan) for sucking in and blowing out air and generating an air flow, in particular a room air flow, at least one conveying device (or: supplying device, transferring device, feeding device) for conveying (or: supplying, transferring, feeding) the treatment substance or agent, in particular from a treatment container, and at least one feed nozzle, which is connected or can be connected to an outlet of the conveying device via a connecting line, for feeding the treatment substance or agent to the air, in particular room air. For this purpose, the at least one feed nozzle is arranged or can be arranged at, on or in the air flow, in particular room air flow, which is sucked in or blown out by the blower.

If an essentially liquid treatment substance (or: agent) is present, the feed nozzle is preferably an atomising nozzle for atomising the treatment substance. If the treatment substance is already directly in the form of an aerosol, the feed nozzle already feeds the treatment aerosol under acceleration or pressure depending on the feed pressure of the conveying device (or pump) and the flow cross-sections in the feed nozzle.

The device can now be used on its own as an autonomous or self-sufficient device and, in a first function, draw in air, in particular room air, from a room area and feed it back to the room area mixed with the treatment substance. However, the device can also be used in a second function, in addition or as an alternative to the first function, to feed treatment substance into a ventilation duct of an existing ventilation and/or air-conditioning system, in particular of a building, aircraft, vehicle or ship. The treatment substance is then distributed via the ventilation and/or air-conditioning system.

For this purpose of the advantageous double or dual functionality of the device, two basic embodiments are provided each on its own or in combination with each other.

In the first embodiment, the same feed nozzle or an end of the connecting line associated with this feed nozzle is removable or detachable and can (now) be arranged at a distance from the device, in particular connectable to a ventilation duct of the ventilation and/or air-conditioning system, in particular of a building, aircraft, ship or vehicle. The supply nozzle and the connection line are therefore movable or mobile here.

In the second embodiment, at least one further feed nozzle, which is also connected or connectable to the conveying device via a connecting line, can be arranged or disposed at a distance from the device and, in particular, can be connected or is connected to a ventilation duct of a ventilation and/or air-conditioning system.

Thus, in other words, the device is provided, on the one hand, as a stand-alone and independent device for treating air, in particular room air, and/or surfaces, wherein the treatment substance is sprayed directly into the air (to be treated), in particular room air, and, on the other hand, for connecting to a ventilation duct, wherein the treatment substance is supplied to the air flow in the ventilation duct. Thus, the device according to the invention can supply the treatment substance both directly to the air, in particular room air, and to the air flow in the ventilation duct. The connection line may also have branches so that several supply or atomisation nozzles and/or ventilation ducts can be connected to it and supplied with the treatment substance. Several parallel connection lines may also be provided, to the ends of which the supply or atomisation nozzles and/or ventilation ducts are connected. In this case, the device can treat the air, in particular room air, and/or surfaces in one or more rooms directly and at the same time also supply the treatment substance to the air flow(s) in one or more ventilation ducts in ventilation and/or air-conditioning systems.

The connecting line is preferably at least partially flexible, in particular in the form of a spray hose. The length of the connecting line is expediently a multiple of the distance between the conveying device and the feed nozzle.

The feed nozzle is preferably made of stainless steel and/or has at least one integrated fine filter.

In an advantageous embodiment, the device has a largely closed housing which has at least one suction opening, preferably at least two suction openings arranged on opposite housing side walls and covered with suction grids, for sucking in air, in particular room air, by means of the at least one blower and/or at least one blow-out opening of the at least one blower, preferably on a front housing wall in an upper region, the blower also preferably being arranged on or inside the housing. Preferably, three outlet openings and/or three blowers are arranged next to each other in an upper area of the housing.

The feed nozzle is preferably arranged or arrangeable near, preferably above, the discharge opening and/or downstream of the blower. Furthermore

in an advantageous embodiment, the feed nozzle is attached, preferably detachably, to a, preferably front, housing wall (of the housing).

The delivery device is generally a pump or a compressor. This allows the treatment substance to be conveyed under pressure. Furthermore, the delivery device is preferably arranged inside the housing.

In an advantageous embodiment, the device comprises at least one treatment substance container for storing or receiving the treatment substance and preferably further comprises a suction line connecting the treatment substance container to an inlet of the conveying device, wherein the treatment substance container is preferably arranged inside the housing, but may also be arranged outside the housing. Preferably, the treatment substance container comprises a screw cap so that the treatment substance can be easily refilled by the user.

In particular, at least one (fill) level sensor (or: level probe) is assigned to the treatment substance container for detecting the amount of treatment substance in the treatment substance container. This allows the current supply of treatment substance in the treatment substance container to be determined at all times.

A further outlet of the delivery device is preferably connected to the treatment substance container via a pressure line, a solenoid valve and a return line. This allows excess treatment substance to be returned to the treatment substance container.

The device may further comprise one or more of the following sensors:
at least one carbon dioxide (CO₂) sensor for detecting the carbon dioxide content in the room air
at least one oxygen sensor for detecting the oxygen content in the room air,
at least one VOC sensor (volatile organic compound sensor) for detecting organic pollutants in the room air
at least one formaldehyde sensor for detecting the formaldehyde content in the room air.

In an advantageous embodiment, the device has at least one electronic and/or electrical control device for controlling the conveying device and the blower and, if applicable, the solenoid valve as a function of input or sensor values, in particular at least one sensor, in particular the fill level sensor, the carbon dioxide sensor, the VOC sensor, the formaldehyde sensor and/or the oxygen sensor. The carbon dioxide content and the oxygen content are essential parameters for the quality of the room air. Formaldehyde is harmful to health and often occurs indoors. For example, formaldehyde is released by furniture made of wood, especially pressboard.

Preferably, the device for further treatment of the air, in particular room air, has at least one air cleaning or air filter unit for cleaning or filtering the air, in particular room air, in particular of suspended particles and germs or other particles, wherein the air cleaning or air filter unit is arranged upstream of the blower with respect to the room air flow and/or wherein an air cleaning or air filter unit is arranged at each intake opening, preferably fastened to the housing wall and/or wherein the air cleaning or air filter unit comprises at least one HEPA filter.

In addition, the device can have a collection device, in particular a simple air sampler and/or at least one removable collection device (air sampler plate) for air germs, which is preferably connected upstream of the or a further blower. The composition of the airborne germs in the collection device corresponds to that in the air, in particular room air. The collecting device (simple air sampler) enables the user to determine the composition of the airborne germs in the air, in particular room air, with little effort. The contaminated collection device (air sampler) can be sent to a laboratory, for example, to have the composition of the airborne germs determined there. The collection device (air sampler) can be replaced.

In particular, the device can have at least one display and operating device, wherein the display and operating device is provided for displaying and setting operating parameters of the device, for manual control of the device by the user and/or for displaying air, in particular room air, parameters, wherein preferably the display and operating device comprises at least one, in particular touch-sensitive, screen.

For example, the display and operating device is provided for displaying a diagram that shows the carbon dioxide content in the air, in particular room air, as a function of time, preferably over a period of 24 hours. This makes it possible to clearly display at what time the carbon dioxide content in the room air is particularly high or low. In particular, it enables the operator to monitor the room air quality and take countermeasures as required, such as opening doors or windows.

Furthermore, the display and operating device and/or the control device can be provided for storing the carbon dioxide content in the room air as a function of time over a past period of at least two days. This enables, for example, a comparison of the values of two consecutive days.

In addition, the display and operating device can have at least one traffic light display for displaying the room air quality, preferably with a red light element for displaying a high carbon dioxide content, a yellow light element for displaying a medium carbon dioxide content and a green light element for displaying a low carbon dioxide content in the room air. This shows the room air quality in a particularly clear form.

For setting the device, it can be provided that the device is controllable with at least one time programme in which the switch-on and switch-off times of the device can be set by the user.

For example, the device can be controlled with at least one long-term programme in which the switch-on and switch-off times of the device can be individually set by the user for each day of the week. The user can set a germ reduction with very low harmless concentrations of treatment substances or also carry out a classic room disinfection with high treatment substance concentrations, during which no humans or animals may be in the room, as high treatment substance concentrations are released.

Alternatively or additionally, the device can be controllable with at least one short-time programme in which the switch-on and switch-off times of the device for the current day can be set by the user.

To move the device, at least four castors, at least two of which are swivel castors, can be provided on its underside, whereby preferably at least one castor has a parking brake. This makes it easy to move the device flexibly within the room and also between different rooms.

Alternatively, the device can also be designed as a table-top device or miniature device. This is particularly advantageous for smaller rooms.

The treatment substance preferably comprises or contains an aqueous hydrogen peroxide solution. Hydrogen peroxide (H₂O₂) inactivates germs, viruses, bacteria, mould, biological contaminants, pathogenic germs and various air pollutants. Furthermore, hydrogen peroxide is completely biodegradable as it decomposes into water and oxygen. As a result, the air, especially room air, is additionally refreshed and humidified with oxygen without any pollutants being released or remaining behind. The hydrogen peroxide content in the treatment substance is between 0.5% and 5%, preferably about 3%. The addition of hydrogen peroxide to the room air is also effective against coronaviruses.

The disinfection or sterilisation function of the device can also be carried out in addition or as an alternative to hydrogen peroxide by other sterilisation components, such as the addition of other sterilising substances that are harmless to health via the feed or atomisation nozzle, such as other approved biocides according to Biocide Regulation EU No. 528/2012, or also treatment with UV radiation.

For connection to the ventilation duct, it may be provided that at least one holder is associated with the device, which holder can be attachable or is attached to the ventilation duct, wherein the supply or atomising nozzle and/or the end of the connection line associated with the supply or atomising nozzle can be attachable or is attached to the holder.

In this case, the holder may comprise a duct or pipe section and a flange surrounding the duct or pipe section, wherein the duct or pipe section is provided for connecting the connecting pipe to the supply nozzle and the flange is attachable or mounted on the outside of the wall of the ventilation duct. In this case, the pipe section is connected between the supply nozzle and the connecting pipe.

Furthermore, the invention relates to a ventilation and/or air-conditioning system, in particular for buildings, vehicles, ships or aircraft, wherein at least one device described above for treating air, in particular room air, and/or surfaces can be connected or is connected to the ventilation and/or air-conditioning system. In an existing ventilation and/or air-conditioning system, treatment of the air, in particular room air, and/or surfaces with the treatment substance can be made possible in this way.

In particular, at least one supply nozzle and/or one end of the connection line of the device associated with the supply nozzle are connected or connectable to at least one supply-side ventilation duct of the ventilation and/or air-conditioning system.

Furthermore, the ventilation and/or air-conditioning system comprises at least one differential pressure detection device arranged on the ventilation duct in the vicinity of the atomising nozzle, wherein preferably the differential pressure detection device is provided for detecting the air flow in the ventilation duct.

Finally, the differential pressure detection device (differential pressure box) can be electrically connected or connectable to the control device of the device. This makes it possible to measure the air flow in the ventilation duct; if there is no air flow, the device switches off automatically.

In one embodiment, the device is designed as a stand-alone device for placing on the floor, as a wall-mounted device for hanging on the wall or as a table-top device or miniature device for placing on a desk, for example.

A method according to the invention is provided for treating, in particular disinfecting, air, in particular room air, and/or surfaces with treatment substance, in particular treatment substance for disinfecting (or: disinfectant), and comprises (the following steps):

sucking in and blowing out air, in particular room air, by at least one blower,

connecting, via a connection line, at least one first feed nozzle to an outlet of at least one conveying device for conveying the treatment substance,

conveying (or: transporting, feeding) by means of the at least one conveying device, the treatment substance to at least one feed nozzle,

feeding the treatment substance into the air flow, in particular room air flow, sucked in or blown out by the blower, by means of the at least one feed nozzle.

In a first embodiment the method further comprises

removing the feed nozzle or an end of the connecting line associated with this feed nozzle and connecting it to a ventilation duct of a ventilation and/or air-conditioning system, in particular of a building, aircraft, ship or vehicle, and feeding the treatment substance into the ventilation duct by means of the feed nozzle.

In a second embodiment which can be provided instead of the first embodiment or in addition to or in combination with the first embodiment the method further comprises

connecting at least one further or second feed nozzle to the conveying device via a connecting line and to a ventilation duct of a ventilation and/or air-conditioning system, in particular of a building, aircraft, ship or vehicle, and feeding the treatment substance into the ventilation duct by means of the further or second feed nozzle.

In a preferred embodiment of the method a device according to any of the embodiments according to the invention is used.

The treatment substance preferably comprises or contains an aqueous hydrogen peroxide solution. The hydrogen peroxide (H₂O₂) content in the treatment substance is between 0.1% and 5%, preferably about 3%.

In a preferred embodiment the feed of the treatment substance at the feed nozzle is controlled, preferably by controlling the conveying device, in feed charges or in feed pulses of predetermined time intervals such as e.g. a few seconds to a few minutes and within a time of for example several hours a day, and can preferably be set by a user.

The amount of treatment substance, preferably the amount at each feed charge or feed pulse, is kept low, typically a few millilitres per feed charge or feed pulse, so that the concentration remains below the maximum admissible values or admissible threshold values for that treatment substance, for instance under the 4000 times the maximum admissible value of H₂O₂ so that humans and animals can in principle stay in the room while the treatment takes place.

Further features, advantages and particular embodiments of the invention are the subject of the claims.

### BRIEF DESCRIPTION OF THE DRAWINGS

The invention is described in more detail below with reference to a preferred embodiment and the drawings. It is shown in

FIG. 1 a schematic perspective view of a treatment device according to a preferred embodiment of the invention,

FIG. 2 a schematic perspective front view of the opened treatment device according to the preferred embodiment of the invention,

FIG. 3 a schematic side view of a ventilation duct section of a ventilation and/or air-conditioning system according to the preferred embodiment of the invention,

FIG. 4 a schematic perspective front view of the ventilation duct section of the ventilation and/or air-conditioning system according to the preferred embodiment of the invention,

FIG. 5 a schematic perspective view of a collection device for airborne microorganisms according to the preferred embodiment of the invention,

FIG. 6 a further schematic perspective view of the collection device for airborne microorganisms according to the preferred embodiment of the invention, and

FIG. 7 a schematic view of a graphical display of room air quality according to the preferred embodiment of the invention.

### DETAILED DESCRIPTION OF THE PREFERRED EMBODIMENTS

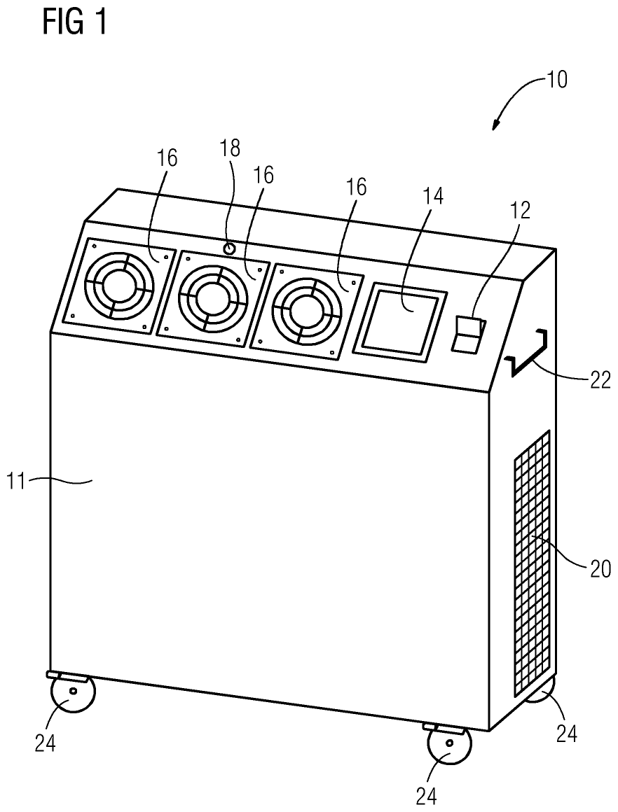

FIG. 1 shows a schematic perspective view of a device 10 for treating air, in particular room air, and/or surfaces according to a preferred embodiment of the invention.

The device 10 has a main switch 12 and a display and operating device 14. The main switch 12 is provided for switching the device 10 on and off. The display and operating device 14 is provided for displaying parameters, in particular room air parameters, and for setting the operating parameters and/or for manual control of the device 10 by the user. In particular, the size of the room can also be set by the user at the display and operating device 14. Preferably, the display and operating device 14 comprises a screen, preferably a touch-sensitive screen (touch display). In particular, the display and operating device 14 is also controlled and/or supported by software.

Furthermore, the device 10 comprises at least one blower 16. In this embodiment example, the device 10 comprises three blowers, in particular axial blowers, 16 arranged side by side, which are integrated in an inclined upper housing wall of a substantially closed housing 11. An atomising nozzle 18 is arranged in the vicinity, preferably above, the blower(s) 16. The atomising nozzle 18 is located in an opening of the housing 11 and is detachably fixed there, for example by means of a threaded or plug-in connection or by means of a snap-on or snap-in connection. Preferably, the atomising nozzle 18 is made of stainless steel and has an integrated fine filter.

In each of the side walls of the housing 11 of the device 10, at least one passage opening with an intake grille 20 is integrated. The intake grille 20 has a plurality of intake openings. The intake openings may be in the form of holes and/or slots. Furthermore, the device 10 comprises a holding handle 22 on each of the two side walls of the housing 11. Preferably, the holding handle 22 is retractable. The handles 22 are provided for transporting and moving the device 10.

Four castors 24 are mounted on the underside of the housing 11 of the device 10. The castors 24 facilitate the mobility of the device 10. Preferably, at least one of the castors 24 includes a parking brake. Alternatively, two swivel castors 24 and two fixed casters may be mounted on the underside of the device 10. In this case, one of the castors 24 also preferably has a parking brake.

The device 10 is also suitable for wall mounting. In particular, there is a lock on the top of the device 10 for locking the housing 11 of the device 10.

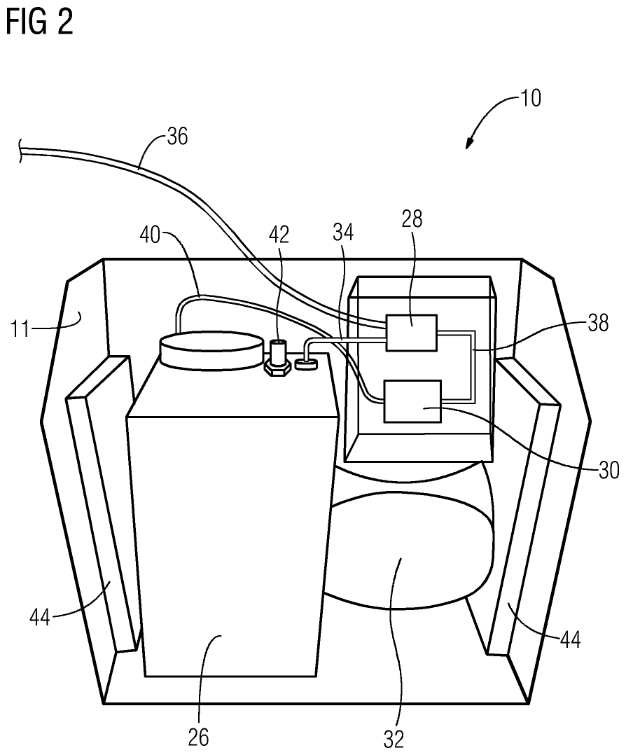

FIG. 2 shows a schematic perspective front view of the opened device 10 for treating air, in particular room air, and surfaces according to the preferred embodiment of the invention.

In the opened device 10 in FIG. 2, the front and top cover of the housing 11 is removed so that the components inside the device 10 are visible. The device 10 has a treatment substance container 26, a pump (or alternatively a compressor) 28, a solenoid valve 30 and an electronic control device 32. In this example, the pump 28 and solenoid valve 30 are contained within a housing, preferably transparent, located within the device 10. In this embodiment, the treatment substance container 26 has a capacity of, for example, 15 litres, but may also have a different capacity.

The treatment substance container 26 has an opening for filling that can be closed, for example, with a screw cap. This allows the user to easily open and fill the treatment substance container 26. The treatment substance container 26 is connected to an inlet of the pump 28 via a suction line 34. An output of the pump 28 is connected to the atomising nozzle 18 via a connecting line, hereinafter referred to as spray hose 36. The atomising nozzle 18 is located at the end of the spray hose 36 and is not shown in FIG. 2. Another output of the pump 28 is connected to the solenoid valve 30 via a pressure line 38. The solenoid valve 30 is in turn connected to the treatment substance container 26 via a return line 40. Excess treatment substance is returned to the treatment substance container 26 via the pressure line 38, the solenoid valve 30 and the return line 40. By opening and closing the solenoid valve 30, pressure is released in the pressure line 38 and the treatment substance is returned via the return line 40 or pressure is also applied to the atomising nozzle via the spray hose 36. Instead of the pump 28, the device can also have a compressor.

Electrical connections are provided between the control device 32, the pump 28, the solenoid valve 30 and the level sensor 42, as well as to the main switch 12 and to the display and operating device 14, which are not shown in FIG. 2 for clarity.

Furthermore, the device 10 comprises two optional air filters 44, which are preferably arranged on the inner sides of the side walls. The air filters 44 each cover one of the intake grilles 20 shown in FIG. 1. Preferably, the air filters 44 are HEPA filters (High-Efficiency Particulate Air filters). The HEPA filter is designed to separate suspended particles from the air. The HEPA filter can separate particles with an aerodynamic diameter smaller than 1 μm. In particular, the air filter 44 is designed to separate bacteria, viruses, pollen, mite eggs, dust particles, aerosols and smoke particles.

In addition, the device 10 comprises a carbon dioxide sensor, which is not shown in FIG. 2. Optionally, the device 10 may include a volatile organic compound (VOC) sensor for sensing organic pollutants, a formaldehyde sensor, and/or an oxygen sensor. The blower 16, pump 28 and solenoid valve 30 are controllable by the control device 32 in response to parameters sensed by the level sensor 42, carbon dioxide sensor, VOC sensor, formaldehyde sensor and/or oxygen sensor. Preferably, the control device 32 is also controlled and/or supported by software.

Finally, the device 10 may comprise an air sampler, which is preferably connected upstream of a further, unspecified blower.

The device 10 is a recirculating air system which draws in room air through the intake grille 20 into the interior of the device 10 inside the housing 11 by means of the blowers 16. Optionally, the room air passes through the air filters 44. The air is blown back out of the interior of the device 10 into the room by the blowers 16. A treatment substance is added to the exiting air via the atomising nozzle 18, as shown in FIG. 1.

The treatment substance is located in the treatment substance container 26. Preferably, the treatment substance is an aqueous hydrogen peroxide solution, optionally with further additives such as flavouring substances or further air treatment substances.

The level sensor 42 is provided for detecting the amount of treatment substance in the treatment substance container 26. For example, the amount of treatment substance is displayed by the display and operating device 14, preferably continuously in steps.

The treatment substance is sucked out of the treatment substance container 26 by means of the pump 28 or a compressor via the suction line 34 and fed to the atomising nozzle 18 via the spray hose 36. This adds hydrogen peroxide atomised by the flexible atomising nozzle 18 to the air exiting through the blowers 16.

Hydrogen peroxide inactivates germs, viruses, bacteria, mould, biological contaminants, pathogenic germs and air pollutants. In addition, hydrogen peroxide decomposes into water and oxygen, so that the room air is enriched with oxygen and humidified and, moreover, no pollutants are released or remain behind. Thus, the treatment substance is completely biodegradable.

For example, the device 10 shown in FIGS. 1 and 2 has a width of about 62 cm, a height of about 60 cm and a depth of about 25 cm. However, the size of the device 10 according to the invention is variable. The device 10 can be provided for different room sizes. According to another embodiment, the device 10 can also be designed as a table-top device that is smaller in dimensions and can be placed, for example, on a desk or a chest of drawers or the like.

On the one hand, the device 10 is provided as an independent, in particular mobile or also permanently installed, device for treating the air, in particular room air, and/or surfaces, whereby the device 10 can be used as a stand-alone device with or without the castors 24 or as a wall-mounted device. The atomising nozzle 18 is or will then be arranged on the device 10 and feeds the atomised treatment substance to the air flow generated by the device 10, be it on the outlet side or downstream or also already inside still inside the housing 11 or upstream.

On the other hand, the device 10 is also intended for connection to a ventilation and/or air-conditioning system for buildings or in a building. The atomising nozzle 18 and/or the spray hose 36 of the device 10 are removable for this purpose and are connected to a ventilation duct 46, preferably on the supply air side, of the ventilation and/or air-conditioning system. Thereby, the treatment substance is added to the air flow in the ventilation duct 46. This means that the atomising nozzle 18 can also be used at a greater distance from the device 10 with a correspondingly long spray hose 36.

However, it is also possible to provide several atomising nozzles with associated or even branched spray hoses for the device 10, so that, for example, recirculation operation with the device itself and supply air operation via the ventilation or air-conditioning system is possible.

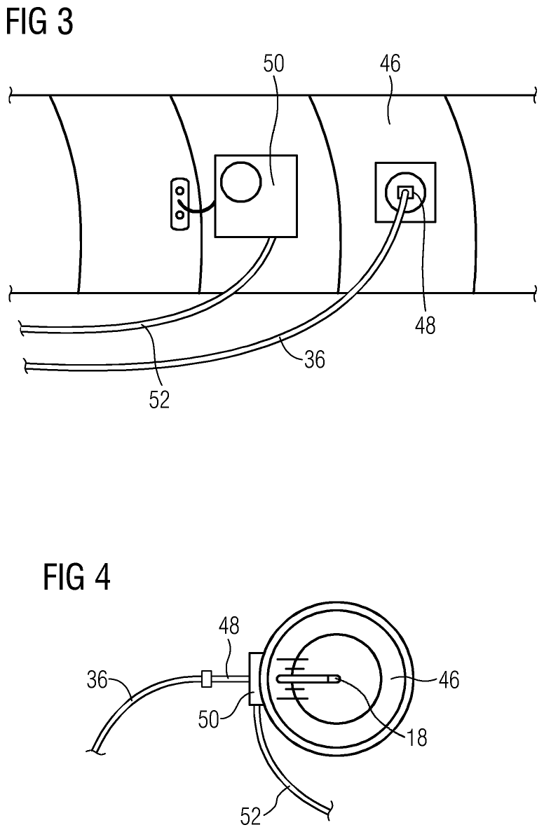

FIG. 3 shows a schematic side view of a ventilation duct section 46 of a ventilation and/or air-conditioning system for buildings according to the preferred embodiment of the invention. The ventilation duct section 46 shown is part of the supply air duct of the ventilation and/or air-conditioning system.

The spray hose 36 of the device 10 is connected to the ventilation duct section 46 so that atomised dilute aqueous hydrogen peroxide is supplied to the airflow in the ventilation duct section 46. In this example, the ventilation duct section 46 is formed as a tube having a circular cross-section. A holder 48 penetrates the wall of the ventilation duct section 46 and connects the spray hose 36 to the atomising nozzle 18. The holder 48 comprises a tube section and a flange surrounding the tube section, the tube section connecting the spray hose 36 to the atomising nozzle 18 and the flange being attached to the outside of the wall of the ventilation duct section 46. The atomising nozzle 18 is located in the centre of the cross-section of the ventilation duct section 46.

In addition to the holder 48, a differential pressure sensing device 50 is arranged on the outside of the ventilation duct section 46. The differential pressure sensing device 50 is electrically connected to the control device 32 of the device 10 via a signal line 52. The differential pressure sensing device 50 is provided for detecting the pressure difference in the ventilation duct section 46. In this way, the air flow in the ventilation duct section 46 is determined. The supply of the treatment substance via the atomising nozzle 18 into the ventilation duct section 46 takes place in dependence on the air flow in the ventilation duct section 46.

In FIG. 4, a schematic perspective front view of the ventilation duct section 46 of the ventilation and/or air-conditioning system according to the preferred embodiment of the invention is shown.

FIG. 4 illustrates the location of the atomising nozzle 18 in the centre of the cross-section of the ventilation duct section 46. The holder 48 connects the spray hose 36 to the atomising nozzle 18. The spray hose 36 and the atomising nozzle 18 are attached to the ventilation duct section 46 by means of the holder 48. Furthermore, the holder 48 connects the spray hose 36 to the atomising nozzle 18. The differential pressure sensing device 50 is projected into the ventilation duct section 46 and detects the air pressure in the ventilation system, depending on the air pressure in the duct, it gives a message to the system and switches it on or off.

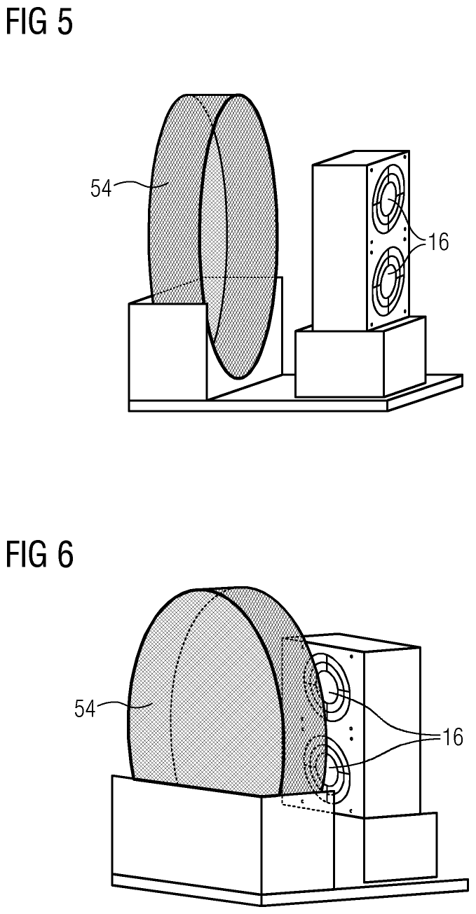

FIG. 5 shows a schematic perspective view of a collection device 54 where an air sampler plate can be used for measuring airborne microbes according to the preferred embodiment of the invention. FIG. 6 shows another schematic perspective view of a collection device 54 for airborne microbes according to the preferred embodiment of the invention.

The air sampler 54 is integrated within the device 10. The air germ plate in the collection device 54 can be exchanged for air germ measurements. Preferably, the same or another blower 16 with a defined volume flow is connected upstream of the collection device 54. The composition of the airborne germs in the collection device 54 corresponds to that in the room air. The collecting device 54 enables the user to determine the composition of the airborne germs in the room air with little effort. For example, the contaminated collection device can be sent to a laboratory to have the composition of the airborne germs in the room air determined there. An on-site analysis of the room air by qualified personnel is not necessary.

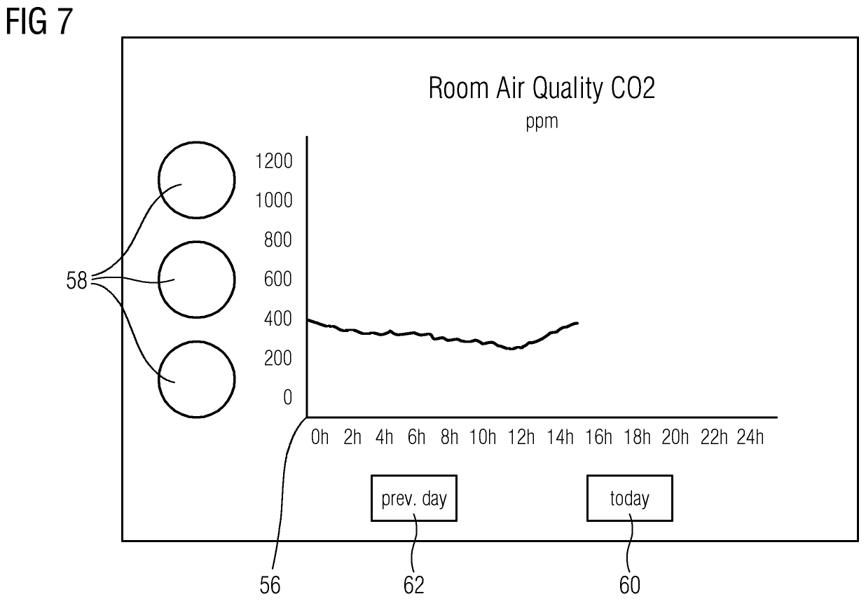

FIG. 7 shows a schematic view of a graphical display of the room air quality according to the preferred embodiment of the invention. In particular, the display and operating device 14 may be provided for graphically displaying the room air quality. For example, the graphical display is shown on a screen.

The graphic display comprises a diagram 56, a traffic light display 58, a “Today” button 60 and a “Previous day” button 62. The diagram 56 represents the carbon dioxide content in the room air as a function of time. Preferably, a period of 24 hours is shown in the diagram 56. The traffic light display 58 shows three illuminated circular discs in the usual colours red, yellow and green. The illuminated circular discs of the traffic light display 58 are always activated alternately depending on the current room air quality. In this example, the green circle of the traffic light display 58 lights up when the carbon dioxide content is less than about 800 ppm, the yellow circle of the traffic light display 58 lights up when the carbon dioxide content is between about 800 ppm and 1000 ppm and the red circle of the traffic light display 58 lights up when the carbon dioxide content is more than about 1000 ppm. The traffic light display 58 clearly signals to the people in the vicinity whether the room air quality is good or bad, for example the integrated CO2 sensor, which is attached to the electronic control 32, i.e. the user can then clearly recognise this and take countermeasures, such as opening doors or windows.

When the “Today” button 60 is pressed, the diagram 56 of the carbon dioxide content in the room air from the current day is displayed. Pressing the “Previous day” button 62 displays the diagram 56 of the carbon dioxide content in the room air from the previous day, which enables a conclusion to be drawn about the CO2 content over time.

Furthermore, the display and operating device 14 is provided for displaying the amount of treatment substance in the treatment substance container 26, which is detected by the level sensor 42. The amount of treatment substance is displayed by the display and operating device 14, preferably permanently. In addition to the diagram 56 and the traffic light display 58, the parameters and other information on the graphic display can also be represented by alphanumeric characters.

The device 10 according to the invention can supply the treatment substance on the one hand directly to the room air and on the other hand to the air flow in the ventilation duct 46. The spray hose 36 can also have branches so that several atomising nozzles 18 can be connected to it and supplied with the treatment substance. In this regard, the device 10 may also simultaneously treat the room air and surfaces in one or more rooms directly and supply the treatment substance to the airflow(s) in one or more ventilation ducts 46. This is advantageous in buildings where only some of the rooms are connected to the ventilation and/or air-conditioning system.

In a preferred embodiment the feed of the treatment substance at the feed nozzle is controlled, preferably by controlling the conveying device, in feed charges or in feed pulses of predetermined time intervals such as e.g. a few seconds to a few minutes and within a time of for example several hours a day, and can preferably be set by a user.

The amount of treatment substance, preferably the amount at each feed charge or feed pulse, is kept low, typically a few millilitres per feed charge or feed pulse, so that the concentration remains below the maximum admissible values or admissible threshold values for that treatment substance, for instance under the 4000 times the maximum admissible value of H₂O₂ This has the great advantage that humans and animals can stay in the room while the air treatment takes place.

The aqueous hydrogen peroxide solution inactivates germs, viruses, bacteria, mould, biological contaminants, pathogenic germs and air pollutants. coronavirus has also been shown to be inactivated in room air and on surfaces by the device 10 according to the invention and the aqueous hydrogen peroxide solution. Tests have shown that with the device 10 according to the invention and the aqueous hydrogen peroxide solution as treatment substance, the coronavirus is inactivated with an effective effect of 99.94%.

The invention relates in particular to a flexible device and a harmless method which make it possible to treat air, room air, surfaces, ventilation systems, vehicles, aircraft and ships in a running operation and in the presence of people and animals in doses and dosing intervals of an aqueous treatment substance calculated in advance on the air quantity in the room in such a way that a harmless, permanently lasting low germ level is achieved in the rooms, in the air, on surfaces and in ventilation systems within the meaning of the German Infection Protection Act. Furthermore, the room air quality is simultaneously refreshed, humidified, degermed and improved through oxygen activation.

Pathogens such as bacteria, germs, viruses, biological impurities and various air pollutants are permanently reduced, filters and inaccessible areas in the ventilation and air-conditioning systems are also treated over a large area and a long-lasting lack of germs is produced. The invention will additionally protect people, animals, air, rooms and food products from pathogens and infections to a previously unattained level (a long-lasting low germ level). The preferentially used aqueous treatment substance is also effective against the coronavirus, among other things, and decomposes into water and oxygen in a 100% environmentally friendly and completely biologically residue-free manner. A treatment substance is used that is also formed in the human and animal body, for example in saliva itself, and is broken down in the body and is naturally formed and contained in nature in rain or snow. The treatment substance used is also naturally contained in natural foodstuffs such as honey. The invention and the method developed will not cause any incompatibilities or allergies in humans or animals, but the dosage lists calculated and worked out beforehand must be adhered to.

The invention also enables classical room disinfection, in particular of air, room air, surfaces and ventilation systems. During room disinfection, no humans or animals may be present in the room during disinfection due to the high concentrations of the treatment substance released.

### REFERENCE SIGNS

10 Device
11 Housing
12 Main switch
13 Housing wall
14 Display and operating device
16 Blower
18 Nozzle
20 Intake grille
22 Holding handle
24 Castor, swivel castor
26 Treatment substance container
28 Pump
30 Solenoid valve
32 Control device
34 Suction line
36 Spray hose
38 Pressure line
40 Return line
42 Level sensor
44 Air filter
46 Ventilation duct, ventilation duct section
48 Holder for atomising nozzle
50 Differential pressure sensing device
52 Signal line
54 Collection device for airborne germs
56 Diagram
58 Traffic light display
60 “Today” button
62 “Previous day” button

1-20. (canceled)

21. A device for treating, in particular disinfecting, air, in particular room air, and/or surfaces with treatment substance, in particular treatment substance for disinfecting, the device comprising:
a) at least one blower for sucking in and blowing out air, in particular room air;
b) at least one conveying device for conveying the treatment substance;
c) at least one feed nozzle for feeding the treatment substance;
d) wherein the feed nozzle is connected or connectable to an outlet of the conveying device via a connection line;
e) wherein the at least one feed nozzle is arranged or can be arranged at or in the air flow sucked in or blown out by the blower, in particular room air flow;
f) wherein the feed nozzle or an end of the connecting line associated with this feed nozzle is removable or detachable and can also be arranged at a distance from the device, in particular can be connected to a ventilation duct of a ventilation and/or air-conditioning system, in particular of a building, aircraft, ship or vehicle;
and/or
g) wherein, alternatively or additionally, at least one further feed nozzle, which is connected or connectable to the conveying device via a connecting line, can be arranged or is arranged at a distance from the device, in particular can be connected or is connected to a ventilation duct of a ventilation and/or air-conditioning system, in particular of a building, aircraft, ship or vehicle.

22. The device according to claim 21, wherein the treatment substance is liquid and/or can be atomised to form an aerosol and the feed nozzle is an atomising nozzle for atomising the treatment substance.

23. The device according to claim 21, wherein:
the connecting line is at least partially flexible, in particular in the form of a spray hose; and/or
the length of the connecting line is a multiple of the distance between the conveying device and the feed nozzle; and/or
the feed nozzle is made of stainless steel and/or has at least one integrated fine filter.

24. The device according to claim 21, comprising:
a housing with at least one suction opening, preferably at least two suction openings arranged on opposite housing side walls and covered with suction grids, for sucking in air, in particular room air, by means of the at least one blower arranged on or in the housing and/or with at least one outlet opening of the at least one blower, preferably on a front housing wall in an upper region;
wherein in particular three outlet openings and/or three blowers are arranged next to one another in an upper region of the housing.

25. The device according to claim 24, wherein:
the feed nozzle is or can be arranged in the vicinity of, preferably above, the discharge opening and/or downstream of the blower; and/or
the feed nozzle is attached, preferably detachably, to a, preferably front, housing wall of the housing.

26. The device according to claim 21, wherein the conveying device:
is a pump or a compressor; and/or
is arranged inside the housing.

27. The device according to claim 21, comprising:
at least one treatment substance container for storing the treatment substance and preferably further comprising a suction line connecting the treatment substance container to an inlet of the conveying device;
wherein:
the treatment substance container is preferably arranged within the housing;
preferably a further outlet of the conveying device is connected to the treatment substance container via a pressure line, a solenoid valve and a return line; and/or
preferably at least one level sensor is associated with the treatment substance container for detecting the amount of treatment substance in the treatment substance container.

28. The device according to claim 21, further comprising:
at least one carbon dioxide sensor for detecting the carbon dioxide content in the air, in particular room air; and/or
at least one oxygen sensor for detecting the oxygen content in the air, in particular room air; and/or
at least one VOC sensor (volatile organic compound sensor) for detecting organic pollutants in the air, in particular room air; and/or
at least one formaldehyde sensor for detecting the formaldehyde content in the air, in particular room air; and/or
at least one electronic and/or electrical control device for controlling the conveying device and the blower and, if appropriate, the solenoid valve, as a function of input or sensor values, in particular input values of at least one sensor, in particular the level sensor, the carbon dioxide sensor, the VOC sensor, the formaldehyde sensor and/or the oxygen sensor.

29. The device according to claim 21, comprising:
at least one air cleaning or air filter unit for cleaning or filtering the air, in particular room air, in particular of suspended particles and/or germs;
wherein:
the air cleaning or air filter unit is arranged upstream of the blower with respect to the air flow, in particular room air flow, and/or
an air cleaning or air filter unit is arranged at each intake opening, preferably fastened to the housing wall; and/or
the air cleaning or air filter unit comprises at least one HEPA filter and/or
at least one removable airborne germ collection device, preferably directly upstream of the or a further blower.

30. The device according to claim 21, further comprising:
at least one display and operating device, wherein the display and operating device is provided for displaying and setting operating parameters of the device, for manual control of the device by the user and/or for displaying room air parameters;
wherein:
preferably the display and operating device comprises at least one, preferably touch-sensitive, screen, wherein preferably the display and operating device is provided for displaying a graph showing the carbon dioxide content in the room air as a function of time, preferably over a period of 24 hours; and/or
preferably the display and operating device and/or the control device is provided for storing the carbon dioxide content in the room air as a function of time over a past period of at least two days; and/or
preferably the display and operating device comprises at least one traffic light display for indicating the room air quality, preferably a red light element for indicating a high carbon dioxide content, a yellow light element for indicating a medium carbon dioxide content and a green light element for indicating a low carbon dioxide content in the room air.

31. The device according to claim 21, wherein the device is:
controllable by at least one time program in which the switch-on and switch-off times of the device (10) are adjustable by the user; and/or
controllable with at least one long-term programme in which the switch-on and switch-off times of the device (10) are individually adjustable by the user for each day of the week; and/or
controllable by at least one short-time program in which the switch-on and switch-off times of the device (10) for the current day are adjustable by the user.

32. The device according to claim 21, wherein at least four castors, at least two of which are swivel castors, are provided on the underside of the device, preferably at least one castor having a parking brake.

33. The device according to claim 21, wherein the device is designed as a floor-mounted device for standing on the floor, as a wall-mounted device for hanging on the wall or as a table-top device or miniature device for standing on, for example, a desk.

34. The device according to claim 21, wherein an aqueous hydrogen peroxide solution is provided as or at least as a part of the treating substance, preferably the hydrogen peroxide content in the treating substance being between 0.1% and 5%, preferably about 3%.

35. The device according to claim 21, further comprising:
at least one holder which can be attached or is attached to the ventilation duct;
wherein:
the feed nozzle and/or the end of the spray hose associated with the feed nozzle can be attached or is attached to the holder;
preferably the holder comprises a tube portion and a flange surrounding the tube portion, the tube portion being provided for connecting the spray hose to the feed nozzle and the flange being attachable or mounted to the outside of the wall of the ventilation duct.

36. A ventilation and/or air-conditioning system, in particular for a building, aircraft, ship or vehicle, which at least one device for treating air, in particular room air, and/or surfaces comprising:
a) at least one blower for sucking in and blowing out air, in particular room air;
b) at least one conveying device for conveying the treatment substance;
c) at least one feed nozzle for feeding the treatment substance;
d) wherein the feed nozzle is connected or connectable to an outlet of the conveying device via a connection line;
e) wherein the at least one feed nozzle is arranged or can be arranged at or in the air flow sucked in or blown out by the blower, in particular room air flow;
f) wherein the feed nozzle or an end of the connecting line associated with this feed nozzle is removable or detachable and can also be arranged at a distance from the device, in particular can be connected to a ventilation duct of a ventilation and/or air-conditioning system, in particular of a building, aircraft, ship or vehicle;
and/or
g) wherein, alternatively or additionally, at least one further feed nozzle, which is connected or connectable to the conveying device via a connecting line, can be arranged or is arranged at a distance from the device, in particular can be connected or is connected to a ventilation duct of a ventilation and/or air-conditioning system, in particular of a building, aircraft, ship or vehicle on the supply air side, preferably with at least one holder.

37. The ventilation and/or air-conditioning system according to claim 36, further comprising:
at least one differential pressure sensing device arranged on the ventilation duct in the vicinity of the supply nozzle;
wherein:
preferably the differential pressure sensing device is provided for detecting the air flow in the ventilation duct; and
preferably the differential pressure sensing device is electrically connected or connectable to the control device of the device.

38. A method for treating, in particular disinfecting, air, in particular room air, and/or surfaces with treatment substance, in particular treatment substance for disinfecting, comprising:
a) sucking in and blowing out air, in particular room air, by at least one blower
b) connecting, via a connection line, at least one first feed nozzle to an outlet of at least one conveying device for conveying the treatment substance,
c) conveying by means of the at least one conveying device, the treatment substance to at least one feed nozzle,
c) feeding the treatment substance into the air flow, in particular room air flow, sucked in or blown out by the blower, by means of the at least one feed nozzle,
d) removing the feed nozzle or an end of the connecting line associated with this feed nozzle and connecting it to a ventilation duct of a ventilation and/or air-conditioning system, in particular of a building, aircraft, ship or vehicle, and feeding the treatment substance into the ventilation duct by means of the feed nozzle,
and/or
e) connecting at least one further feed nozzle to the conveying device via a connecting line and to a ventilation duct of a ventilation and/or air-conditioning system, in particular of a building, aircraft, ship or vehicle, and feeding the treatment substance into the ventilation duct by means of the further feed nozzle.

39. Method according to claim 38, wherein the method is performed by a device comprising:
a) at least one blower for sucking in and blowing out air, in particular room air;
b) at least one conveying device for conveying the treatment substance;
c) at least one feed nozzle for feeding the treatment substance;
d) wherein the feed nozzle is connected or connectable to an outlet of the conveying device via a connection line;
e) wherein the at least one feed nozzle is arranged or can be arranged at or in the air flow sucked in or blown out by the blower, in particular room air flow;
f) wherein the feed nozzle or an end of the connecting line associated with this feed nozzle is removable or detachable and can also be arranged at a distance from the device, in particular can be connected to a ventilation duct of a ventilation and/or air-conditioning system, in particular of a building, aircraft, ship or vehicle;
and/or
g) wherein, alternatively or additionally, at least one further feed nozzle, which is connected or connectable to the conveying device via a connecting line, can be arranged or is arranged at a distance from the device, in particular can be connected or is connected to a ventilation duct of a ventilation and/or air-conditioning system, in particular of a building, aircraft, ship or vehicle on the supply air side, preferably with at least one holder.

40. The method according to claim 38, wherein:
the treatment substance comprises or contains an aqueous hydrogen peroxide solution with a hydrogen peroxide content preferably between 0.1% and 5%
and/or
the feed of the treatment substance at the feed nozzle is controlled, preferably by controlling the conveying device, in feed charges or in feed pulses of predetermined time intervals such as e.g. a few seconds to a few minutes and can preferably be set by a user;
and/or
the amount of treatment substance, preferably the amount at each feed charge or feed pulse, is kept so low, typically a few millilitres per feed charge or feed pulse, that the concentration of the treatment substance in the air remains well below the maximum admissible values for that treatment substance, for instance under 4000 times the maximum admissible value of H₂O₂.
